(19) United States
(12) Patent Application Publication
(10) Pub. No.: US 2025/0367689 A1
(43) Pub. Date: Dec. 4, 2025

(54) FLUID DIFFUSION AND STORAGE CARTRIDGE SYSTEM AND METHOD

(71) Applicant: Hypnos Virtual, Inc., Little Rock, AR (US)

(72) Inventor: Michael D. Kaczkowski, Little Rock, AR (US)

(21) Appl. No.: 18/733,625

(22) Filed: Jun. 4, 2024

Related U.S. Application Data
(63) Continuation-in-part of application No. 17/825,053, filed on May 26, 2022.
(63) Continuation-in-part of application No. 17/689,517, filed on Mar. 8, 2022, now Pat. No. 12,329,903.
(60) Provisional application No. 63/311,530, filed on Feb. 18, 2022.
(60) Provisional application No. 63/311,530, filed on Feb. 18, 2022.

(51) Int. Cl. B05B 7/26; B05B 7/24

(52) U.S. Cl. CPC B05B 7/265; B05B 7/2486

(57) ABSTRACT

A unitary cartridge designed to store and diffuse and dispense fluid via atomization is provided. The system generally comprises a cartridge, fluid, manifold, and air supply, wherein the air supply injects air through the manifold and into the cartridge through an air inlet of the cartridge. The air is manipulated by the cartridge in a way that creates a stream of fast-moving air above a fluid within the cartridge. This results in a zone of lower pressure above the fluid that results in the fluid to be suctioned into said stream of fast-moving air where it is atomized. The atomized fluid is then carried by the stream of fast-moving air out an atomization outlet where it is dispersed within the environment. One embodiment includes multiple cartridges, each containing different liquids, removably mounted to a common manifold supplying pressurized air to each cartridge, each of which diffuses the respective liquid and disperses the atomized liquid into a shared environment for mixing.

### CROSS REFERENCES

This application claims the benefit of U.S. Provisional Application No. 63/311,530, filed on Feb. 18, 2022, and U.S. Utility patent application Ser. No. 17/689,517 filed Mar. 8, 2022, and U.S. Utility patent application Ser. No. 17/825,053 filed May 26, 2022, which applications are incorporated herein by reference.

### FIELD OF THE INVENTION

The subject matter of the present disclosure refers generally to a system and method for a cartridge designed to store liquid for atomization, atomize the liquid through diffusion, and dispense the atomized vapor. The cartridge is of unitary construction (without moving or removable parts), using a material providing all of said functionalities while avoiding the disadvantages of prior art having multiple components made of varying materials having respective disadvantages associated with each such material. The cartridge is also part of a multi-cartridge system for coordinated fluid dispersal of mixtures of atomized vapors.

### BACKGROUND OF THE INVENTION

Plant essences, botanical fluids, and other plant distillates, commonly called “essential oils,” are distilled fluids of plants, vegetables, nuts, seeds, roots, bark, flowers, etc. In some cases these distilled fluids can be made from non-organic substances as well but these will be included within the term “essence”, “botanical fluid”, “essential oil” or just “fluid” for sake of simplicity as well as “isolates” will also be included within these terms. These botanical fluids and essences typically have medicinal and/or therapeutic properties in addition to their valuable aromas that can be used in combination to create desirable fragrances. Unfortunately, the extraction of botanical fluids and essences from source plants is sometimes complicated, and comparatively expensive, based on the cost per unit volume of the botanical fluid and essence. As a result, colognes, perfumes, olfactory displays, and the like often use high rates of diluents with essences to reduce cost. They also may incorporate synthetic fluids, oils and artificial scents that may not replicate the comforting, familiar, and natural aroma of the natural essence. And most importantly, do not contain the beneficial medicinal and/or therapeutic properties the botanical fluids and essences possess due to their complex organic chemistry. Therefore, there has been interest in ways to efficiently disperse essences in a way that best keep their beneficial bio-chemical properties.

Evaporation rates or atomization rates of essences are often inadequate though, meaning that in order to provide a controllable, sustainable, and sufficient amount of said botanical fluids in the surrounding environment to achieve a desired effect, one must provide some sort of mechanism to increase the amount in the environment. Therefore, one of the most common methods of atomization, wicking diffusers, often prove inadequate since they possess no air movement mechanism. As a result, other forms of diffusion have become increasingly popular for dispensing botanicals throughout an environment. These methods of diffusion include ultrasonic diffusers, oil lamps, candle diffusers, and aroma heaters, which all work by heating a fluid so that a botanical is dispersed into the surrounding environment. Though these are all effective methods of diffusion, heat often destroys or at least changes the constitution of essences. Thus, these methods of diffusion have limitations.

Known in the field are diffusers that function without heat. Due to the corrosive characteristics of the liquids targeted for diffusion in such devices, often the device has a reservoir made of glass or other material that is resistant to corrosion by the liquid within the reservoir. However, until the creation of this invention, it has apparently not been possible to utilize a single corrosion resistant material for constructing the infrastructure delivering the liquid to the diffusion apparatus; nor has it been technically possible to use the same corrosion resistant material for making the reservoir and the diffusion apparatus itself, which is often made of high physical property hard plastic or metal. Often the infrastructure will include a tube made of extruded high-density polyethylene (HDPE) which us resistant to the chemicals being diffused, for movement of the liquid from the reservoir to the diffusion apparatus. This entails the use of rings and/or pressure gaskets to seal each interface with the HDPE tube to enable sufficient air pressure for diffusion, but gaskets are typically made of low-durometer rubber material that enable compression, and thus are susceptible to corrosion, requiring routine replacement.

Thus, the current design, fabrication techniques and art requires the use of multiple components constructed of various materials (dictated by each component's structural and functional needs), to be intricately interconnected to enable a successful diffuser and dispersal device. However, this existing art and design requiring multiple parts and varied materials working together brings with it many problems and disadvantages for the manufacture and functioning of dispersal systems, such as:
gaskets are needed for airtight connections under increased air pressure, but have a short lifespan;
gaskets and the other diffusor parts need to be manually opened up for refilling the reservoir, replacing the gaskets and/or tubing, and disconnecting and reconnecting the air supply;
the diffuser devices are not able to be made compact in size due to these many parts and various materials, and are thus not unable to also function as cartridges for dispersal system use;
multiple parts need to be manufactured and inventoried, and labor costs are required for tedious assembly of the diffusor devices; and.
the air line connecting to these diffusor/dispersal devices must also be manually attached/reattached, also inhibiting cartridge connection functionality.

Further, hypersonic diffusers/atomizers work by diffusing water particles into the surrounding environment, wherein said water particles then carry the botanical fluids into the surrounding environment. This results in the dilution of the botanical fluids in addition to increasing the humidity of the environment, which may not be a desired feature. To make matters worse, water, botanical fluids, and/or essences diffused by hypersonic diffusers often damage surrounding equipment, furniture, and objects within the environment. Moreover, the “spitting” of botanical fluids and/or essences into the surrounding environment by hypersonic diffusers results in comparatively large droplets of said botanical fluids and/or essences, which can not only be particularly devastating to finishes of furniture but also wastes a substantial fraction of the botanical fluids and/or essences, driving up the cost to the user of said hypersonic diffuser.

Accordingly, there is a need for a system that stores targeted essences, atomizes the essence into vapor, distributes the vapor into a surrounding environment more efficiently, and can be used and placed into a multi-diffusor system for controlled mixing of vapors. One primary objective of the invention disclosed herein is to provide a cartridge that stores corrosive botanical liquids and essences safely, and diffuses the liquids into atomized vapors, and disperses the vapors into the environment, all without needing to replace or adjust parts that may become corroded or otherwise malfunctioning.

An additional objective of the invention is to enable a diffusion device to function also as a cartridge that efficiently performs the storage and diffusion and dispersal functions in a very small volume of space, and are additionally engineered to facilitate quick, spill-free, replacement (or swapping for different essences) without the need for manual removal of air lines.

Another objective is to enable a diffusion device to also be a reuseable and replaceable cartridge, readily interchangeable in multi-cartridge systems engaged in mixing and customizing phytochemistry, aromas, and other essences.

Another objective is to provide a liquid storage and diffusion and dispersal cartridge that can “snap in and snap out” of a multi-cartridge system that disperses mixtures of atomized fluids.

Additional objectives of the invention will become apparent from the review of the present disclosure.

### SUMMARY

In general, the system disclosed herein comprises (includes) a cartridge defining an integrated storage reservoir (for liquid to be diffused) in fluid communication with a vacuum channel (supplying that liquid to the diffusion location), which is in fluid communication with an air duct (supplying pressurized air to the diffusion location) for nebulizing the liquid into an atomized vapor transported by the air flow to an atomization outlet for exiting the cartridge for inhaling by humans. The cartridge disclosed herein is ideally made using a production-grade 3D printer, although other means of manufacture might accomplish the integration of the various functionalities into a very small single-piece cartridge that can store the corrosive liquids needing to be nebulized, and perform the diffusion needed for such atomization, and expel a desired amount of the atomized vapor into the adjoining environment for use. Preferably, the cartridge includes a casing forming the following internal negative-space components, without any separate parts:
(a) a reservoir formed within the casing for holding the liquid to be atomized;
(b) an air channel/duct formed within the casing, including an upstream air inlet and a downstream choke point having a cross-sectional area smaller than the cross-sectional area of the duct upstream of the choke point;
(c) an atomization outlet seamlessly integrated into the casing structure; and
(d) a vacuum channel also integrally formed of negative-space, including a junction point in fluid communication with the reservoir, and an upper connection point in fluid communication with the air duct downstream of and near the choke point.

Air supplied by an unclaimed air supply enters the air inlet under pressure and travels into the air duct and through the choke point, converting the air into an air jet and lowering the air pressure of the air duct downstream of and near the choke point, creating a Venturi vacuum suctioning the liquid up the vacuum channel and into the air jet, thereby atomizing the liquid and propelling it out of the atomization outlet.

Preferably the cartridge is of unitary (single-piece) construction. More preferably, the cartridge is of unitary construction using a single material capable of satisfying all of the structural and functional requirements of all of the functional portions of the cartridge. Such integration requires more than just combining pre-existing functional components into a single housing; the use of known materials and arrangements of components failed to provide a device having this compact size and that was capable of performing the storage and diffusion and dispersal functions without interruptions caused by corrosion and the interplay of removable parts during refilling.

The cartridge disclosed herein was primarily intended to be one of several such cartridges deployed within a small portable housing enclosing a computer-governed system synthesizing a vapor by mixing atomized sprays of different essences to produce scents that produce desired medical or psychological effects when inhaled together. As needed, the cartridges efficiently perform both storage and diffusion functions in a very small volume of space, and are additionally engineered to facilitate quick, spill-free, replacement (or swapping for different essences).

A system and method for a cartridge used to distribute a fluid via cold-air atomization is provided. In one aspect, the system distributes fluid into its surrounding environment via a jet of air. In another aspect, the system holds a fluid designed in a position such that it is pulled into the atmosphere by a jet of air. Generally, air from an air supply enters an air inlet of a cartridge, wherein it is manipulated by the cartridge in a way that creates a stream of fast-moving air above a liquid within the cartridge, which causes the liquid within the vacuum channel to be suctioned into said stream of fast-moving air where it is atomized. The atomized fluid is then carried by the stream of fast-moving air out the atomization outlet where it is dispersed within the environment. Therefore, the system of the present embodiment atomizes fluid into the surrounding environment without the need of heat or a carrier fluid such as water.

The system generally comprises a fluid, cartridge, manifold, and air supply, wherein the air supply injects air through the manifold and/or cartridge in a way that causes the fluid to atomize. The cartridge comprises a hard casing having an air inlet, atomization outlet, fluid reservoir, vacuum channel, and air duct. The manifold comprises at least one attachment point for removably securing the cartridge thereto. An air delivery element or outlet of the manifold is configured to align with the air inlet of the cartridge. The air supply may secure to the manifold in a way such that it may provide air to the cartridge through the manifold. As air is pushed through the air duct of the cartridge by the air supply, a choke point within the air duct causes the air to become of a stream of fast-moving air. Because the choke point is located directly in front of the point in which the air duct meets the vacuum channel, a zone of reduced pressure is created above the vacuum channel, resulting in the atomization.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### DESCRIPTION OF THE DRAWINGS

These and other features, aspects, and advantages of the present disclosure will become better understood with regard to the following description, appended claims, and accompanying drawings where:

FIG. 1 is a perspective view of a system embodying features consistent with the principles of the present disclosure.

FIG. 2 is a perspective view of a cartridge embodying features consistent with the principles of the present disclosure.

FIG. 3 is a front view of a cartridge embodying features consistent with the principles of the present disclosure.

FIG. 4 is a back view of a cartridge embodying features consistent with the principles of the present disclosure.

FIG. 5 is a left-side view of a cartridge embodying features consistent with the principles of the present disclosure.

FIG. 6 is a right-side view of a cartridge embodying features consistent with the principles of the present disclosure.

FIG. 7 is a top view of a cartridge embodying features consistent with the principles of the present disclosure.

FIG. 8 is a bottom view of a cartridge embodying features consistent with the principles of the present disclosure.

FIG. 9 illustrates how fluid and air flows through a cartridge embodying features consistent with the principles of the present disclosure.

FIG. 10 is a flow chart illustrating certain method steps of a method embodying features consistent with the principles of the present disclosure.

FIG. 11 is a flow chart illustrating certain method steps of a method embodying features consistent with the principles of the present disclosure.

FIG. 12 is a perspective view of a representative sample of a storage diffusion cartridge disclosed herein, without the screw-on cap.

FIG. 13 is a first side elevation view of the cartridge of FIG. 12.

FIG. 14 is a side elevation view of the opposite side of the cartridge of FIG. 13.

FIG. 15 is a side elevation view of the cartridge of FIG. 13, rotated 90 degrees.

FIG. 16 is a top plan view of the cartridge of FIG. 12.

FIG. 17 is a bottom plan view of the cartridge of FIG. 12.

FIG. 18 is a cross-section view of the cartridge of FIG. 12, at plane 18-18 of FIG. 16.

FIG. 19 is a perspective view of a 4-cartridge manifold holding four cartridges.

FIG. 20 is a side elevation of the manifold and one cartridge of FIG. 19.

FIG. 21 is a top plan view of the manifold and cartridges of FIG. 20.

FIG. 22 is a side elevation view of the manifold and cartridges of FIG. 19, with the locking tabs of the cartridges captured within the tab receivers of the manifold.

FIG. 23 is an opposite side elevation view of the manifold and cartridges of FIG. 22.

FIG. 24 is a side elevation view of the manifold and one cartridge on the end of the manifold, in a locked in position.

FIG. 25 is a side elevation view of the manifold and cartridge of FIG. 24, with the cartridge positioned diagonally with its foot tab received within the receptacle of the manifold, for either locking in, or being released from, the manifold.

FIG. 26 is a cross-section view of the manifold and cartridge of FIG. 25.

FIG. 27 is a bottom plan view of the manifold of FIG. 19.

### DETAILED DESCRIPTION OF THE INVENTION

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising”, or “includes” and/or “including”, or “have” or “having”, when used in this specification, specify the presence of stated features, regions, integers, steps, operations, elements and/or components, but do not preclude the presence or addition of one or more other features, regions, integers, steps, operations, elements, components and/or groups thereof.

For the sake of simplicity and to give the claims of this patent application the broadest interpretation and construction possible, the conjunctive “and” may also be taken to include the disjunctive “or,” and vice versa, whenever necessary to give the claims of this patent application the broadest interpretation and construction possible. Likewise, when the plural form is used, it may be taken to include the singular form, and vice versa.

The term “unitary” and grammatical equivalents thereof are used herein to mean constructed with one material and undivided in form (whole or indivisible single piece); “unitary” may include a plurality of parts constructed of the same or chemically-related material(s), bonded together into an indivisible single piece.

The feature or features of one embodiment may be applied to or found in other embodiments, even though not described or illustrated, unless expressly prohibited by this disclosure or the nature of the embodiment or feature(s).

In the Summary above and in this Detailed Description, and the claims below, and in the accompanying drawings, reference is made to particular features, including method steps, of the invention. It is to be understood that the disclosure of the invention in this specification includes all possible combinations of such particular features. For instance, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For instance, a system “comprising” components A, B, and C can contain only components A, B, and C, or can contain not only components A, B, and C, but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

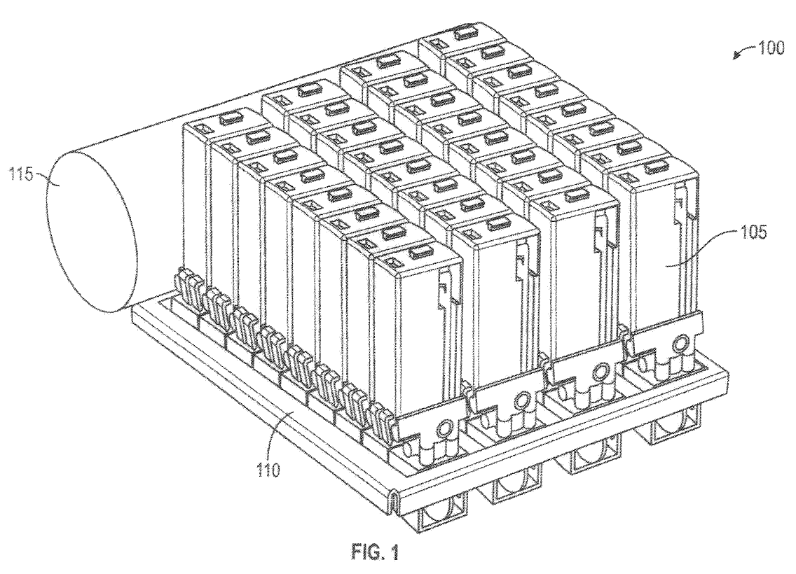

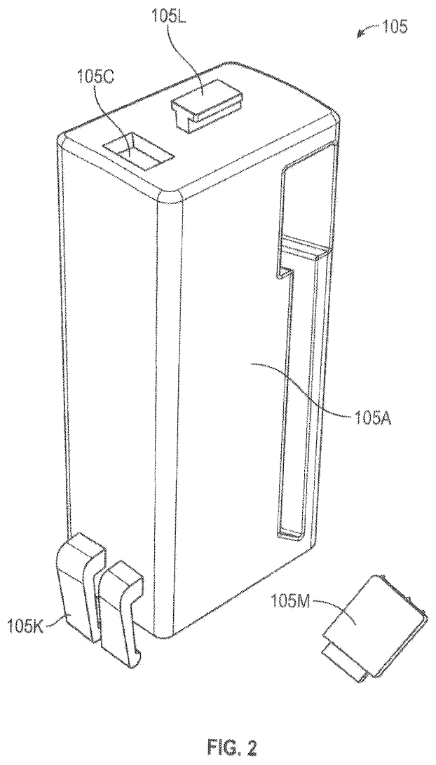

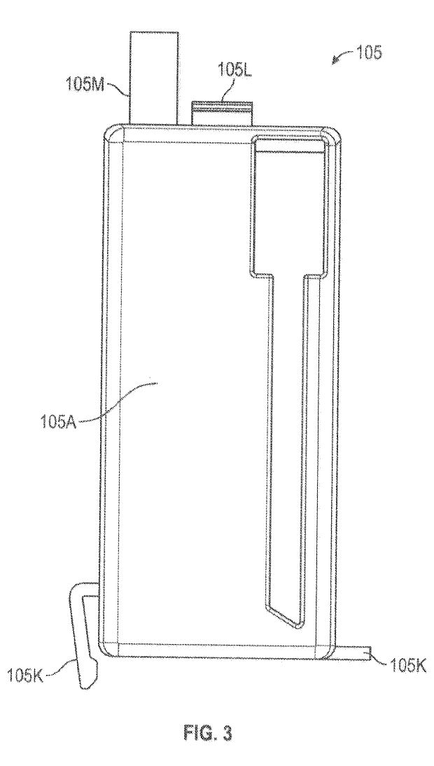

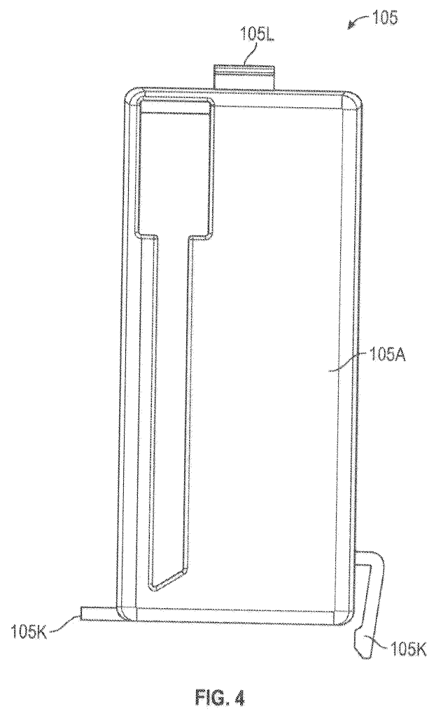

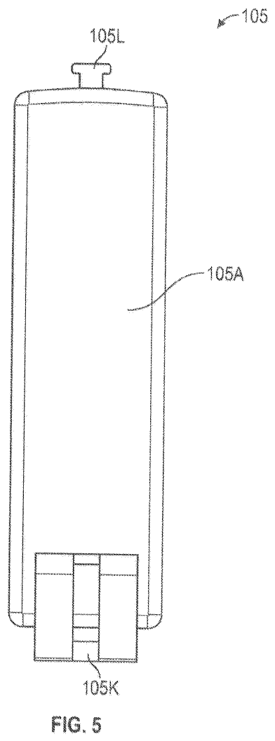

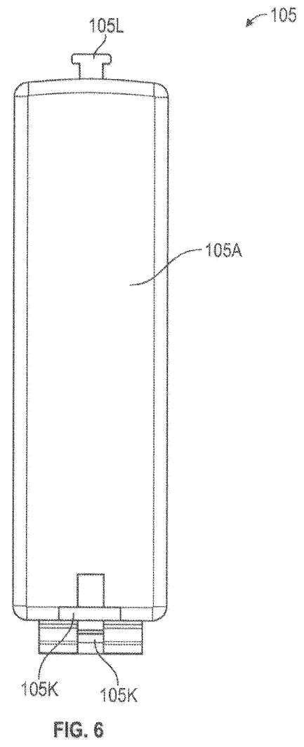

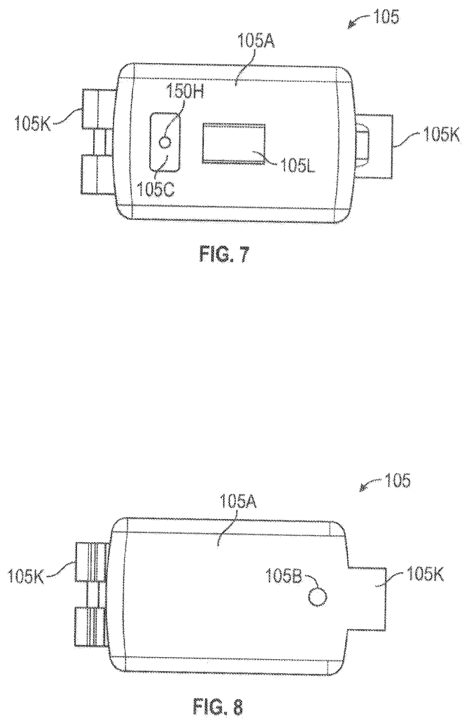

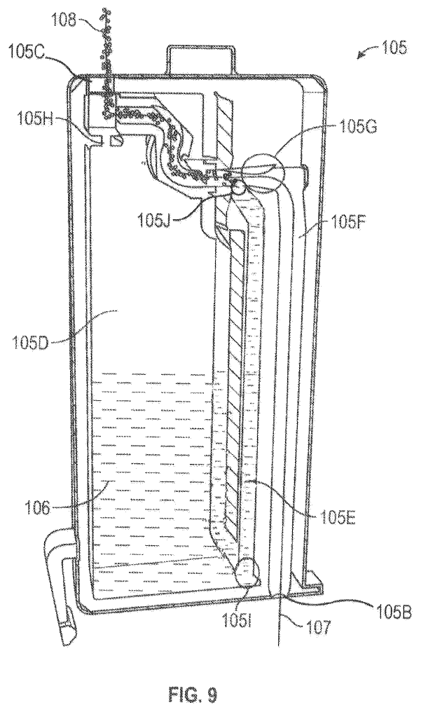

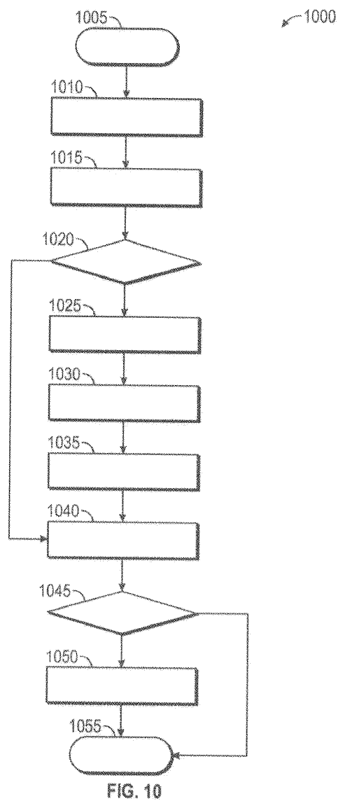

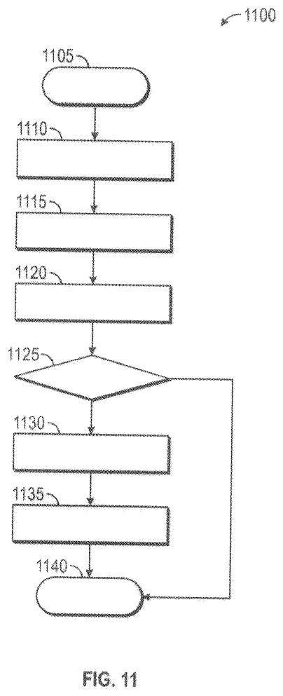

FIGS. 1-11 illustrate embodiments of a system 100 configured to atomize a fluid 106 into an environment using air 107. FIG. 1 illustrates a perspective view of a system 100 designed to distribute a fluid 106 into a surrounding environment. FIG. 2 illustrates a perspective view of a cartridge 105 designed to distribute a fluid 106 into a surrounding environment. FIG. 3 illustrates a front view of a cartridge 105 designed to distribute a fluid 106 into a surrounding environment. FIG. 4 illustrates a back view of a cartridge 105 designed to distribute a fluid 106 into a surrounding environment. FIG. 5 illustrates a left-side view of a cartridge 105 designed to distribute a fluid 106 into a surrounding environment. FIG. 6 illustrates a right-side view of a cartridge 105 designed to distribute a fluid 106 into a surrounding environment. FIG. 7 illustrates a top view of a cartridge 105 designed to distribute a fluid 106 into a surrounding environment. FIG. 8 illustrates a bottom view of a cartridge 105 designed to distribute a fluid 106 into a surrounding environment. FIG. 9 illustrates the manner in which the cartridge 105 distributes fluid 106 into a surrounding environment. FIGS. 10 and 11 illustrate methods that may be carried out by a user using the cartridge 105. It is understood that the various method steps associated with the methods of the present disclosure may be carried out as operations by the system 100 depicted in FIGS. 1-9.

The system 100 generally comprises a fluid 106, cartridge 105, and air supply 115, wherein the air supply 115 injects air 107 through the cartridge 105 in a way that causes the fluid 106 to atomize. In one preferred embodiment, as illustrated in FIG. 1, the cartridge 105 is removably secured to a manifold 110 of the air supply 115 in a way that allows a user to remove a first cartridge 105 from the manifold 110 and secure a second cartridge 105 in its place, permitting a user to quickly replace cartridges 105 should the need arise. For instance, should a first cartridge 105 run out of fluid 106, the user may obtain a second cartridge 105 containing a desired fluid 106, remove the first cartridge 105 from the manifold 110, and secure the second cartridge 105 thereto. For instance, should the user desire a different fluid 106 to be atomized/nebulized/sprayed into the surrounding environment than that of the first cartridge 105, the user may swap the first cartridge 105 having a first fluid 106 with a second cartridge 105 having a second fluid 106.

As illustrated in FIGS. 1-9, the cartridge 105 comprises a hard casing 105A having an air inlet 105B and an atomization outlet 105C. In a preferred embodiment, the cartridge 105 is made of hard plastic, glass, enamel, or any combination thereof. However, other materials suitable for making a hard casing 105A may be used without departing from the inventive subject matter described herein. As illustrated in FIG. 9, a fluid reservoir 105D within the hard casing 105A is configured to hold the fluid 106 therein, and a vacuum channel 105E connected to said fluid reservoir 105D at a bottom connection point 1051 and an air duct 105F at a top connection point 105J allows a portion of the fluid 106 to encounter the stream of fast-moving air 107. In a preferred embodiment, the air duct 105F moves air 107 having an initial velocity from the base end of the cartridge 105 towards a choke point 105G of the air duct 105F located towards the top end of the cartridge 105. The choke point 105G of the air duct 105F is a point in which the air duct 105F narrows, resulting in a lower cross-sectional area of the air duct 105F.

Additionally, in some preferred embodiments, as illustrated in FIG. 9, the air duct 105F is configured to expand past the choke point 105G and top connection point 105J until it reaches the atomization outlet 105C and any outlet vent louvre 105M, which causes the stream of fast-moving air 107 to be directed towards the environment. However, in other preferred embodiments, the air duct 105F may not extend past the choke point 105G and top connection point 105J but instead opens up into the fluid reservoir 105D, allowing for atomized fluid to both collect within the fluid reservoir 105D and move out of the atomization outlet 105C and/or the outlet vent louvre 105M. Because the choke point 105G is positioned directly upstream of the top connection point 105J, as illustrated in FIG. 9, the resulting Venturi effect causes the constricted air 107 to speed up as it reaches the top connection point 105J, resulting in a drop in pressure over said vacuum channel 105E. This drop in pressure causes the fluid 106 within the vacuum channel 105E to be suctioned into the stream of fast-moving air 107 at the top connection point 105J, where it is atomized and moved by the stream of fast-moving air 107 towards the atomization outlet 105C.

In some preferred embodiments, the hard casing 105A may further comprise an attachment element 105K, a grasping element such as a knob 105L, and outlet vent louvre 105M, wherein the attachment element 105K and knob 105L are configured to be used in conjunction with a manifold 110, whereas the outlet vent louvre 105M can be used to direct or adjust the outflow of atomized liquid from the atomization outlet 105C. The manifold 110 is configured in a way such that the air supply 115 attaches thereto so that the air supply 115 may supply air 107 to one or more cartridges 105 through said manifold 110. As illustrated in FIG. 1, a single manifold 110 may be used by an air supply 115 to provide air 107 to a single cartridge 105 or a plurality of cartridges 105 at once. In one representative example, the manifold includes a central airway supplying air separately to each air delivery element 111 of the manifold, each of which interfaces with the air duct inlet of a respective cartridge one the cartridge is locked onto its bay on the manifold. Each air delivery element may include a solenoid valve or other controllable mechanism for opening and closing the fluid communication between the air delivery element and the air duct inlet.

A cartridge 105 may be secured to the manifold 110 using the attachment element 105K, and the knob 105L may be used to assist a user when attaching or removing a cartridge 105 to or from the manifold 110. In a preferred embodiment, the attachment element 105K is a locking tab and foot tab, as illustrated in FIGS. 1-9, which secure the base end of the cartridge 105 to the manifold 110. In a preferred embodiment, an air outlet of the manifold 110 is aligned with the air inlet 105B of the cartridge 105 such that air 107 is supplied to the cartridge 105 from the air supply 115 and through said manifold 110 when the base end of the cartridge 105 is secured to said manifold 110. The knob 105L is preferably located on the top end of the hard casing 105A, as illustrated in FIGS. 1-9, in a way that assists a user to grip the cartridge 105 when removing it from the manifold 110. This is necessary in instances when a cartridge 105 of a plurality of cartridges 105 secured to a manifold 110 is difficult to grip due to said cartridge's 105 location within said plurality of cartridges 105, as illustrated in FIG. 1.

As illustrated in FIGS. 2 and 3, an outlet vent louvre 105M may be configured to be secured within the atomization outlet 105C, changing the height and/or angle at which a fluid is dispersed into a surrounding environment. The length and/or angle of the outlet vent louvre 105M may vary based on the fluid 106 being dispersed by the cartridge 105. For instance, a fluid 106 that is more easily atomized and dispersed into the surrounding environment may have an outlet vent louvre 105M having a shorter length, wherein the shorter length only slightly increases the height in which the atomized fluid 108 is distributed. For instance, a fluid 106 that is less easily atomized and dispersed into the surrounding environment may have an outlet vent louvre 105M having a longer length, wherein the longer length greatly increases the height in which the atomized fluid 108 is distributed. Some cartridges 105 may not need an outlet vent louvre 105M if the fluid 106 is exceptionally easy to disperse into a surrounding environment. In some preferred embodiments of the cartridge 105, the outlet vent louvre 105M may be incorporated into the hard casing 105A of the cartridge 105.

The air supply 115 is configured to provide air 107 to the cartridge 105 so that the fluid 106 therein may be atomized and dispersed into the environment. Types of air supplies 115 that may be used by the system 100 include, but are not limited to, an air pump, air compressor, compressed air canister, or any combination thereof. In a preferred embodiment, an air pump is used to push air 107 through a cartridge 105 and/or manifold 110. In some preferred embodiments, the air pump may be secured to the manifold and/or cartridge via tubing. But in a preferred embodiment, the air pump may be incorporated into the manifold and/or cartridge that eliminates the need for tubing, creating a system with less parts that may be less prone to failure or necessitate cleaning less frequently. Additionally, filters of the air pump may be used to prevent the buildup of particulates in the manifold and/or cartridge, further eliminating the need for frequent cleaning. Types of air pumps that may be used by the system 100 include, but are not limited to, reciprocating pumps and rotary vane pumps. A switch of the pump may allow a user to activate the pump. In some preferred embodiments, one or more secondary switches may allow a user to control output of the pump, causing the pump to increase or decrease the flow of air 107 moving through the cartridge 105 and/or manifold 110.

The system 100 may comprise a power supply. The power supply may be any source of power that provides the air supply 115 with electricity. In one preferred embodiment, the system 100 may comprise multiple power supplies that may provide power to the system 100 in different circumstances. For instance, the system 100 may be directly plugged into a stationary power outlet, which may provide power to the system 100 so long as it remains within a certain distance of said stationary power supply. However, the system 100 may also be connected to a mobile power supply, such as a battery, so that the system 100 may receive power even when the system 100 is not connected to a stationary power outlet. In this way, the system 100 may always receive power so that a user may atomize a fluid 106 regardless of the location.

The fluid 106 contained within the cartridge 105 is preferably a natural, concentrated, liquid aromatic or medicinal fluid with or without aroma, such as cannabidiol, essences, botanical fluids, essential oils, and terpenes. The fluid 106 may be injected into the fluid reservoir 105D via a reservoir hole 105H that may be accessed via the atomization outlet 105C, as illustrated in FIG. 9. Additionally, the reservoir hole 105H allows atomized fluid 108 that collects within the air duct 105F and around the atomization outlet 105C to flow back into the reservoir in way such that it does not block the air duct 105F. Therefore, in some preferred embodiments, the cartridge 105 may be refilled by the user once the fluid 106 within the reservoir is spent, and the cartridge 105 is self-cleaning in that air 107 moving through the cartridge 105 prevents debris from entering the atomization outlet 105C while recondensed atomized fluid 108 has at least one path that allows it to flow back to the fluid reservoir 105D. As such, a single cartridge 105 may be used to atomize a plurality of fluid 106s and/or mixture of fluids 106 without departing from the inventive subject matter herein.

One general embodiment is a system configured to store and atomize and disperse an unclaimed liquid, including a casing defining:
(a) a reservoir holding the liquid to be atomized and may include a base aperture;
(b) an air duct may include an upstream air inlet and a downstream choke point having a cross-sectional area smaller than the cross-sectional area of the air duct upstream of the choke point;
(c) an atomization outlet; and
(d) a vacuum channel may include a junction point in fluid communication with the base aperture, and an upper connection point in fluid communication with the air duct downstream of and near the choke point. The vacuum channel may further include a channel choke point terminating at the upper connection point.

Air supplied by an unclaimed air supply enters the air inlet under pressure and travels into the air duct and through the choke point, converting the air into an air jet and lowering the air pressure of the air duct downstream of and near the choke point, creating a Venturi vacuum suctioning the liquid up the vacuum channel and into the air jet, thereby atomizing the liquid and propelling it out of the atomization outlet.

The system may further include a manifold whereby the air supply supplies air to the air inlet, and includes an air delivery element in fluid communication with the air inlet. The manifold may further include an attachment point. The cartridge may further include an attachment element aligned and cooperating with the attachment point to removably secure the cartridge to the manifold. The cartridge attachment element may include a locking tab and the manifold attachment point may include a tab receiver receiving the locking tab. The cartridge may further include a knob for grasping the cartridge for movement to or from the manifold.

The cartridge may further include an atomization outlet vent louvre for adjusting the dispersal rate of atomized liquid from the atomization outlet. The cartridge may further include a reservoir hole providing fluid communication between the reservoir and the air duct, aligned below the atomization outlet; this hole may allow portions of the atomized vapor to return to the reservoir, and it may facilitate refilling of the reservoir with a syringe.

The manifold may further include a separate attachment point for the attachment element of each of a plurality of respective cartridges. The system may further include a control means for controlling the activation and deactivation of each cartridge for the mixing of atomization vapor expelled from the respective cartridges.

In a preferred embodiment, the cartridge includes unitary construction.

FIG. 10 provides a flow chart illustrating certain, preferred method steps that may be used to carry out the method of swapping cartridges 105 to obtain the desired fluid 106 and then operating the system 100 to atomize the desired fluid 106. Step 1005 indicates the beginning of the method. During step 1010, the user may acquire a system 100 comprising a first cartridge 105, manifold 110, and air supply 115. During step 1015, the user may perform a query to determine if the first fluid 106 within the first cartridge 105 is the desired fluid 106. Based on the results of the query, the user may take an action during step 1020. If the user determines that the first fluid 106 within the first cartridge 105 is the desired fluid 106, the user may proceed to step 1040. If the user determines that the first fluid 106 is not the desired fluid 106, the user may obtain a second cartridge 105 having a second fluid 106 therein during step 1025, wherein the second fluid 106 is the desired fluid 106.

Once the user has acquired the second cartridge 105, the user may remove the first cartridge 105 from the manifold 110 during step 1030. In a preferred embodiment, the user must manipulate an attachment element 105K and knob 105L to remove the first cartridge 105 from the manifold 110. The user may then attach the second cartridge 105 to the manifold 110 in place of the first cartridge 105 during step 1035. The user may then perform a query to determine whether to turn on the air supply 115 during step 1040, wherein turning on the air supply 115 will cause the system 100 to atomize the desired fluid 106. Based on the results of the query, the user may perform an action during step 1045. If the user determines they do not want to atomize the desired fluid 106, the user may proceed to terminate method step 1055. If the user determines that they would like to atomize the desired fluid 106, the user may engage a switch of the air supply 115 that will cause said air supply 115 to draw power from the power supply and push air 107 through the cartridge 105 during step 1050, resulting in the desired fluid 106 becoming an atomized fluid 108. Once the air supply 115 has been turned on and the desired fluid 106 has become an atomized fluid 108, the method may proceed to terminate step 1055.

FIG. 11 provides a flow chart illustrating certain, preferred method steps that may be used to carry out the method of refilling spent cartridges 105 with a desired fluid 106. Step 1105 indicates the beginning of the method. During step 1110, the user may acquire a system 100 comprising a first cartridge 105, manifold 110, and air supply 115. During step 1115, the user may remove the cartridge 105 from the manifold 110 and may subsequently perform a query to determine if there is a workable amount of desired fluid 106 within said cartridge 105 during step 1120. A workable amount of desired fluid 106 may be defined as the minimum amount of fluid 106 within a cartridge 105 that can be used by the system 100 to create an atomized fluid 108 at a desired rate. Based on the results of the query, the user may perform an action during step 1125. If the user determines that a workable amount of desired fluid 106 is contained within the fluid reservoir 105D of the cartridge 105, the user may proceed to terminate method step 1140. If the user determines that there is not a workable amount of desired fluid 106 within the fluid reservoir 105D, the user may obtain a quantity of desired fluid 106 during step 1130. The user may then add said quantity of desired fluid 106 to said cartridge 105 via the reservoir hole 105H and the atomization outlet 105C until a workable amount of desired fluid 106 is contained within the cartridge 105 during step 1135. Once the user has filled the cartridge 105 with a workable amount of desired fluid 106, the method may proceed to terminate method step 1140.

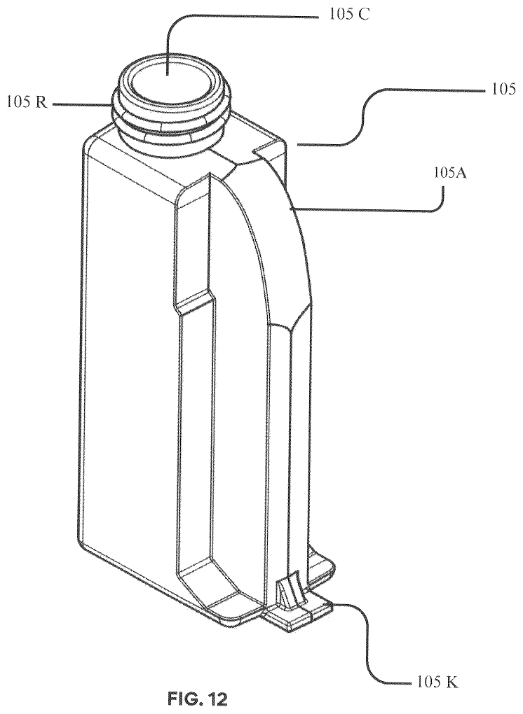

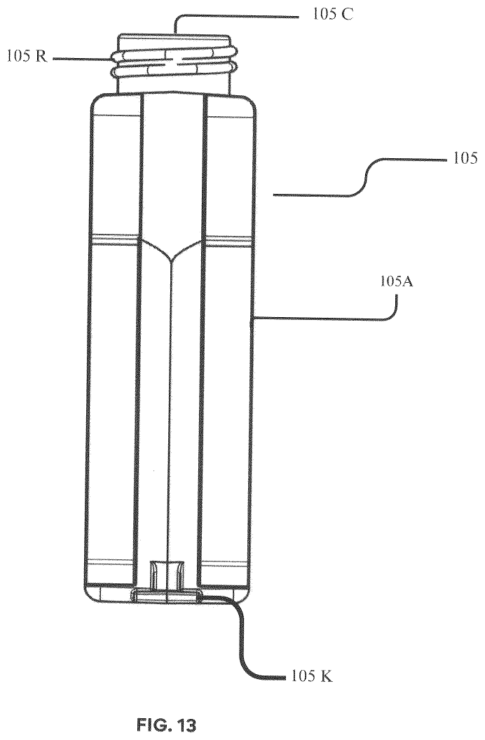

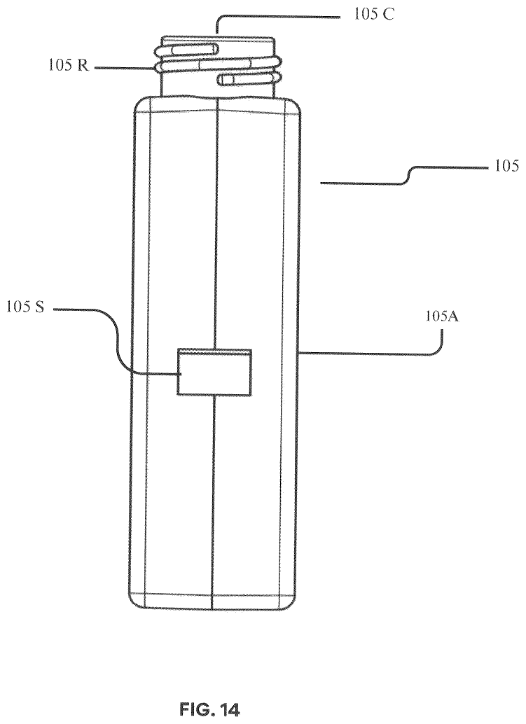

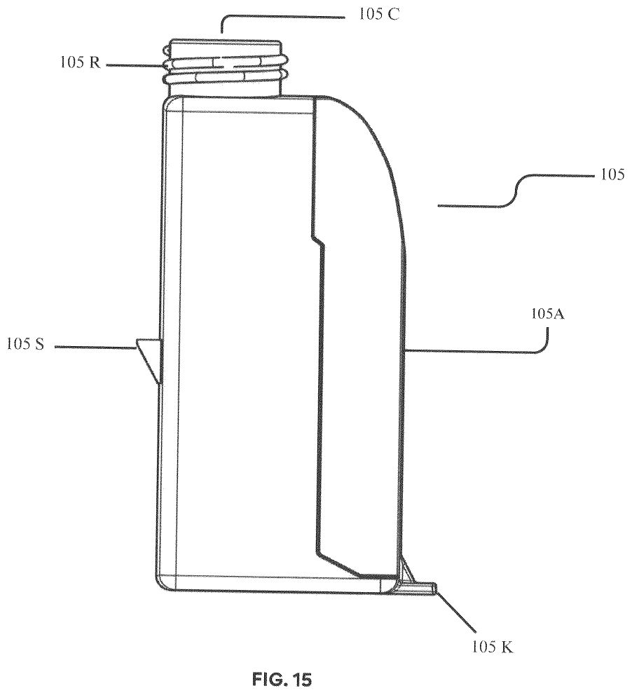

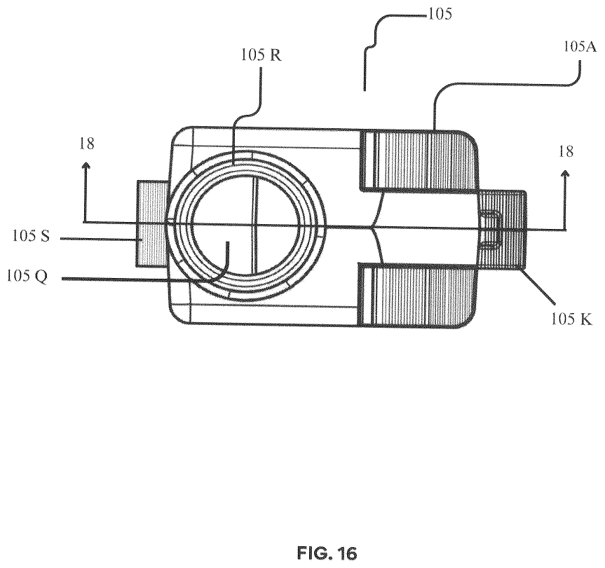

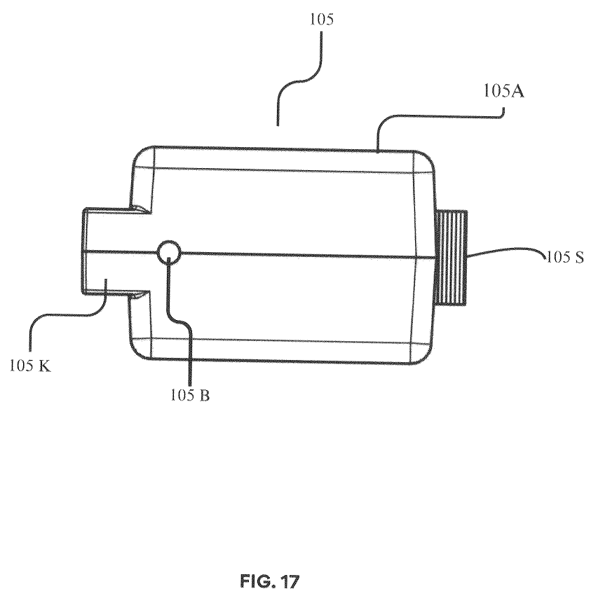

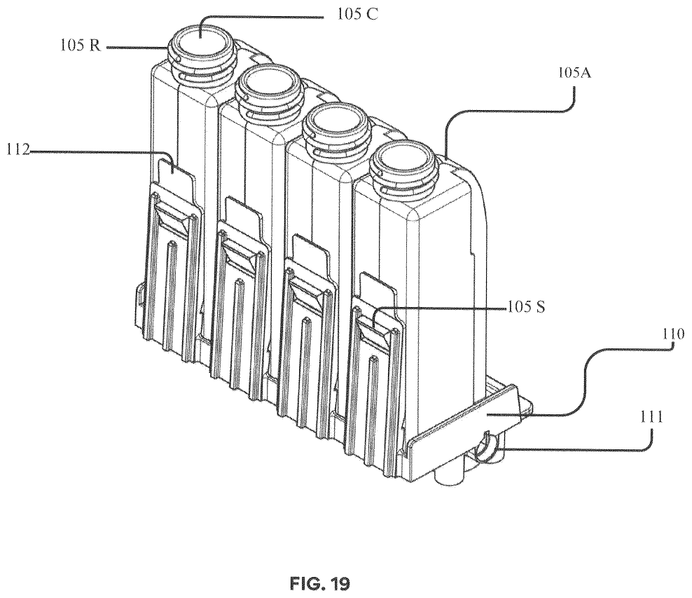

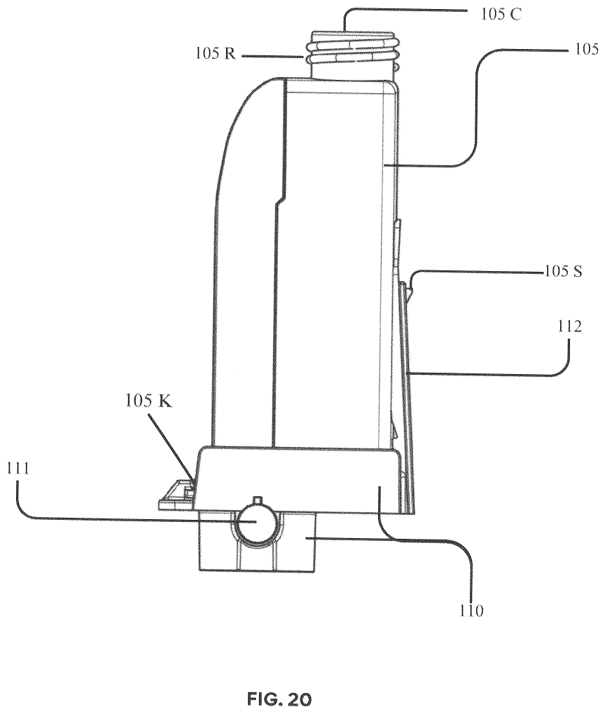

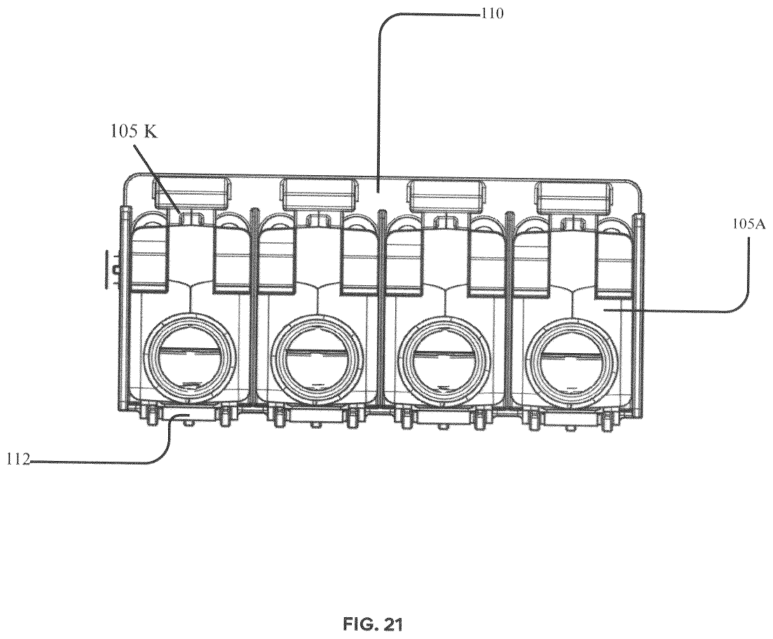

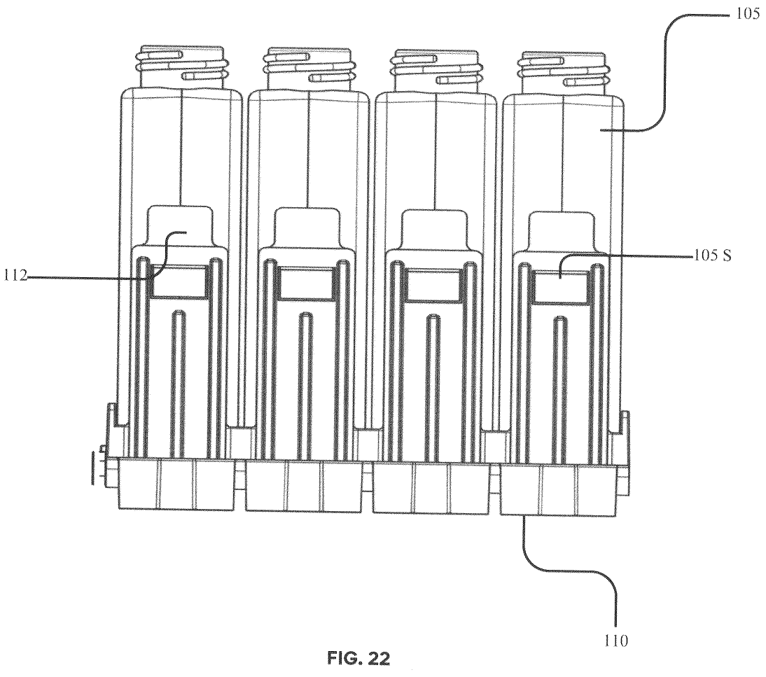

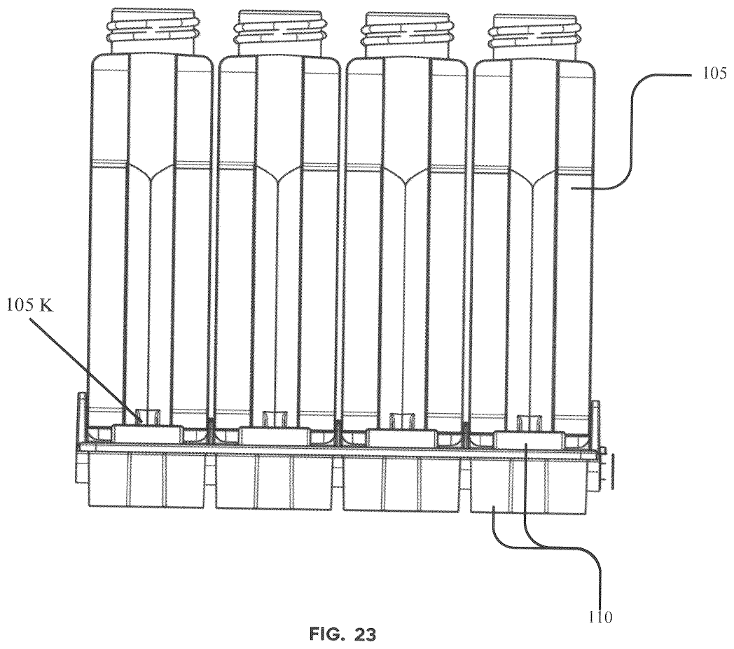

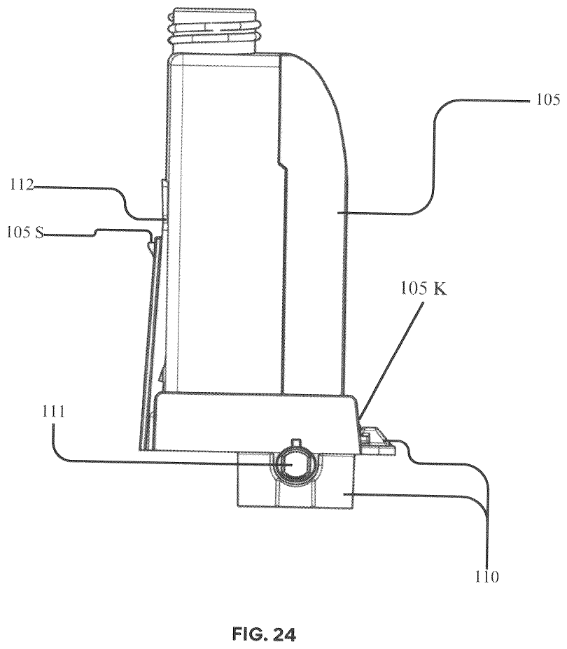

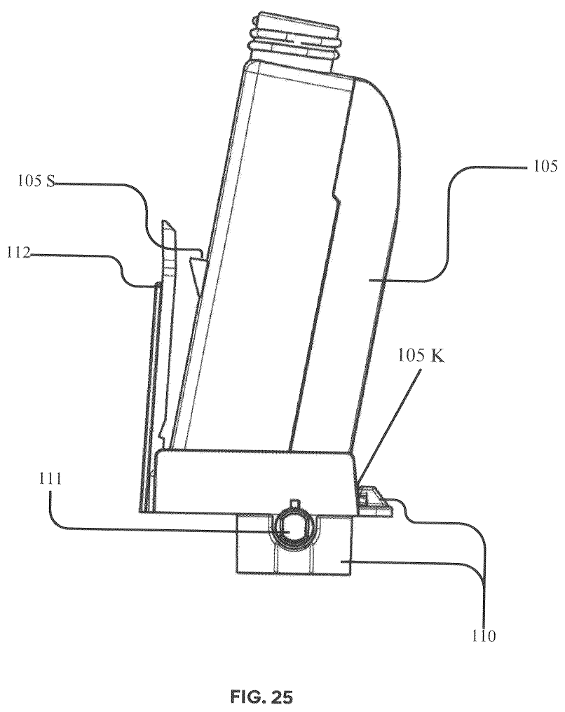

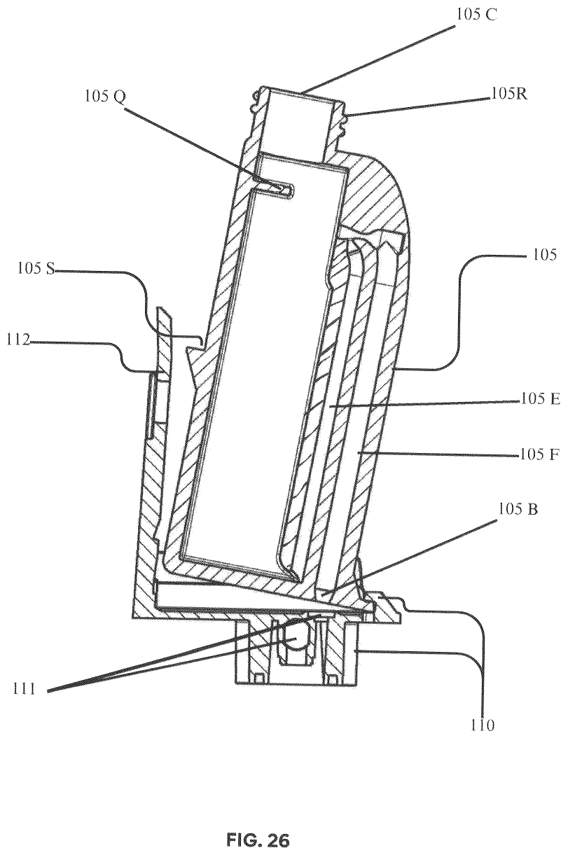

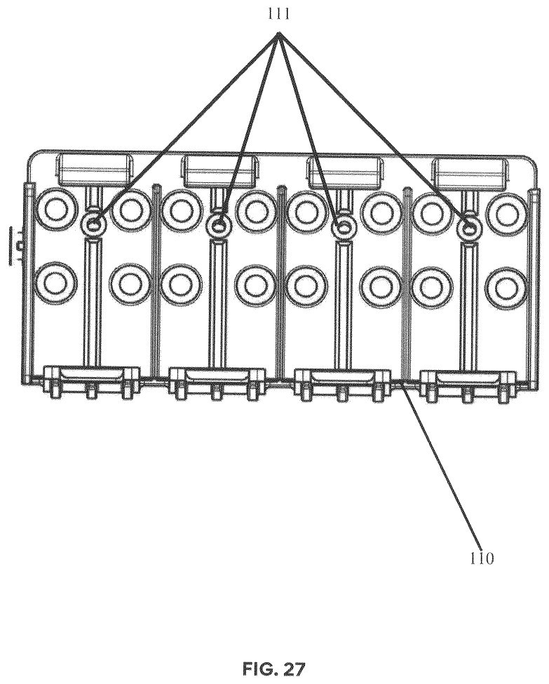

Another embodiment of the cartridge disclosed herein includes (comprises) a flat bottom enabling the cartridge to stand upright while containing liquid, allowing it to function as a storage vessel as well as a diffusion and dispersal device. A representative sample of this embodiment is depicted in FIGS. 12-19.

The commencement of the air duct inlet 105B is defined by an aperture in the bottom of the cartridge, aligned with a corresponding air delivery element 111 of the manifold 110. The air duct 105F extends to and through the choke point 105G, and the vacuum channel 105E merges into the air duct at the upper connection point 105J downstream of the choke point, but the air duct thereafter empties into an upper region of the reservoir which extends to the atomization outlet. The upper region of the reservoir may also include a dispersion rate adjuster element 105Q between the upper connection point and the beginning of the atomization outlet; the dispersion rate adjuster element is essentially a baffle or similar protrusion into the reservoir. Each cartridge can be made for diffusion of liquids have particular physical characteristics or qualities (such as viscosity, weight or other determinant of ease of diffusion), or for diffusion having different dispersal needs (such as high or low volume dispersal); those variables can determine the position and amount of protrusion of the dispersion rate adjuster element. The adjuster element essentially directs a portion of the atomized liquid back into the reservoir, while allowing the desired portion of atomized liquid to flow into the atomization outlet for dispersal.

The atomization outlet is more extended and pronounced to include external threading 105R for rotational mating with an internally threaded screw-on cap (not shown) for such storage functionality. Ideally the cap includes a chemical dome cap for safe storage of corrosive chemicals. (For example, see https://www.bottlestore.com/24-400-black-phenolic-ribbed-side-smooth-top-plastic-cap-ct-pe-cone-1.html.) The screw cap enables an airtight seal. The cartridge also includes a locking tab and/or a foot tab 105K to allow the cartridge to removably attach to the manifold, which was modified to accommodate the new cartridge design.

The reservoir may further include a small hole through the dispersal rate adjuster element, facilitating refilling of the cartridge using a syringe.

An optional seal, using tape or a thin plug, can block the air duct inlet on the bottom of the cartridge.

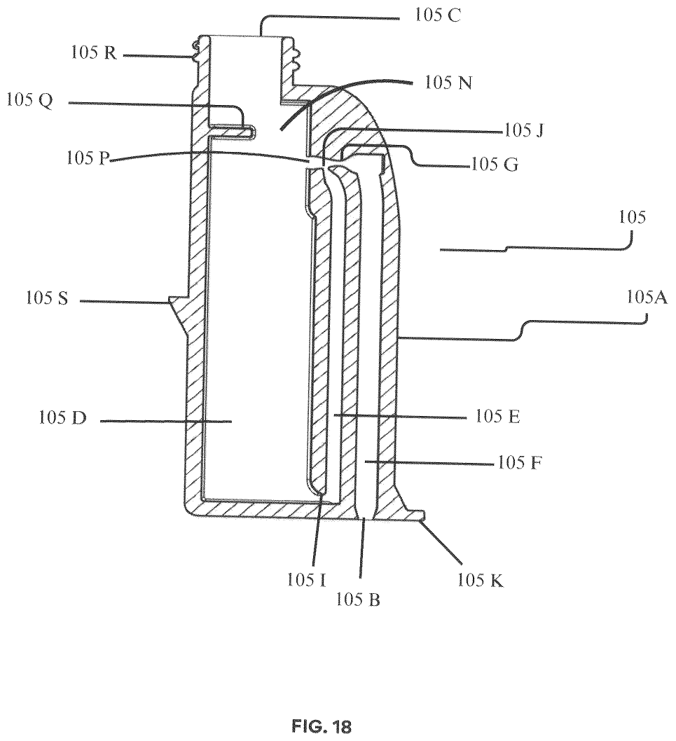

FIG. 18 depicts a representative example of an alternative embodiment more particularly suited for upright storage of the liquids to be atomized, with a flat bottom and the atomization outlet 105C modified to accommodate a screw cap. The air jet of atomized vapor is routed back through the upper gaseous region 105N of the reservoir en route to the atomization outlet. In that region, it may also encounter a dispersal rate adjuster element 105Q to modify the amount of atomized vapor traveling to the atomization outlet.

In one preferred embodiment, the system may include a unitary casing defining:
(a) a reservoir storing the liquid to be atomized and may include a base aperture, an upper gaseous region and an orifice into which an air duct terminates;
(b) said air duct may include an upstream air inlet and a downstream choke point having a cross-sectional area smaller than the cross-sectional area of the duct upstream of the choke point;
(c) a vacuum channel may include a junction point in fluid communication with the base aperture, and an upper connection point in fluid communication with the air duct downstream of and near the choke point; and
(d) an atomization outlet in fluid communication with the upper gaseous region of the reservoir.

The reservoir may further include an upper gaseous region having an orifice into which the air duct, downstream of the upper connection point of the vacuum channel, flows en route to the atomization outlet.

The cartridge may further include a dispersal rate adjuster element within the upper gaseous region between the orifice and the atomization outlet.

The system of claim 1, wherein the cartridge has a flat bottom and the atomization outlet comprises closure means for leak-tight closure of the liquid.

The system may further include a manifold whereby the air supply supplies air to the air inlet, and includes an air delivery element 111 in fluid communication with the air inlet; the manifold may further include an attachment point 112 for the cartridge attachment, and the cartridge may further include an attachment element 105S aligned and cooperating with the attachment point to removably secure the cartridge to the manifold.

The attachment element may include a locking tab 105S and the manifold attachment point may include a tab receiver 112 receiving the locking tab.

The bottom of the cartridge is flat for upright storage of the contents, and the atomization outlet comprises closure means for leak-tight closure of the liquid. The system may further include a screw cap (not shown) having internal threading; the closure means may include external threading on the atomization outlet rotatably mating with the screw cap. The external threading also may function as a grasping element.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For instance, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, materials, and arrangements of the parts and method stages which have been described and illustrated in order to explain the nature of this inventive subject matter can be made without departing from the principles and scope of the inventive subject matter.

Although the present disclosure and its advantages have been described in detail, it should be understood that various changes, substitutions and alterations can be made herein without departing from the spirit and scope of the design as defined by the appended claims. The scope of the present application is not intended to be limited to the particular embodiments of the process, machine, manufacture, composition of matter, means, methods and/or steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. The scope of the present application is not intended to be limited to the particular embodiments of the process, machine, manufacture, composition of matter, means, methods and steps described in the specification.

While a preferred embodiment of the present invention has been described, it should be understood that various changes, adaptations and modifications may be made therein without departing from the spirit of the invention. Changes may be made in details, particularly in matters of shape, size, material, and arrangement of parts without exceeding the scope of the invention.

While the forms of apparatus herein described constitute preferred embodiments of the invention, it is to be understood that the invention is not limited to these precise forms of apparatus, and that changes may be made therein without departing from the scope and spirit of the invention as defined in the appended claims.

Those skilled in the art will recognize improvements and modification to the preferred embodiments of the present disclosure. All such improvements and modifications are considered within the scope of the concepts disclosed herein and the claims that follow.

What is claimed is:

1. A system configured to store and atomize and disperse an unclaimed liquid, the system comprising a casing defining:
(a) a reservoir storing the liquid to be atomized and comprising a bottom connection point;
(b) an air duct comprising an upstream air inlet and a downstream choke point having a cross-sectional area smaller than the cross-sectional area of the air duct upstream of the choke point;
(c) an atomization outlet; and
(d) a vacuum channel comprising a junction point in fluid communication with said bottom connection point, and an upper connection point in fluid communication with said air duct downstream of and near the choke point; and
wherein, air supplied by an unclaimed air supply enters the air inlet under pressure and travels into the air duct and through the choke point, converting the air into an air jet and lowering the downstream air pressure of the air duct near the choke point, creating a Venturi vacuum suctioning the liquid up the vacuum channel and into the air jet, thereby atomizing the liquid and propelling it out of the atomization outlet.

2. The system of claim 1, said system further comprising a manifold whereby the air supply supplies air to said air inlet, and includes an air delivery element in fluid communication with said air inlet.

3. The system of claim 2, said manifold further comprising an attachment point, said cartridge further comprising an attachment element aligned and cooperating with said attachment point to removably secure the cartridge to the manifold.

4. The system of claim 3, said cartridge attachment element comprising a locking tab and said manifold attachment point comprising a tab receiver receiving said locking tab.

5. The system of claim 4, said cartridge further comprising a knob for grasping the cartridge for movement to or from the manifold.

6. The system of claim 1, said cartridge further comprising an atomization outlet vent louvre for adjusting the dispersal rate of atomized liquid from the atomization outlet.

7. The system of claim 1, said cartridge further comprising a reservoir hole providing fluid communication between the reservoir and the air duct below said atomization outlet.

8. The system of claim 1, wherein said reservoir further comprises an upper gaseous region having an orifice into which said air duct, downstream of said upper connection point of the vacuum channel, flows en route to said atomization outlet.

9. The system of claim 8, said cartridge further comprising a dispersal rate adjuster element within said upper gaseous region between said orifice and said atomization outlet.

10. The system of claim 1, wherein said cartridge has a flat bottom and said atomization outlet comprises closure means for leak-tight closure of the liquid.

11. The system of claim 10, said system further comprising a screw cap having internal threading, said closure means comprising external threading on said atomization outlet rotatably mating with the screw cap.

12. The system of claim 2, said manifold further comprising a separate attachment point for the attachment element of each of a plurality of respective cartridges.

13. The system of claim 12, further comprising a control means for controlling the activation and deactivation of each cartridge for the mixing of atomization vapor expelled from the respective cartridges.

14. The system of claim 1, said vacuum channel further comprising a channel choke point terminating at said upper connection point.

15. The system of claim 1, wherein said cartridge comprises unitary construction.

16. A system configured to store and atomize and disperse an unclaimed liquid, the system comprising a unitary casing defining a reservoir storing the liquid to be atomized and comprising a bottom connection point, an upper gaseous region and an orifice into which an air duct terminates; said air duct comprising an upstream air inlet and a downstream choke point having a cross-sectional area smaller than the cross-sectional area of the duct upstream of the choke point; a vacuum channel comprising a junction point in fluid communication with said bottom connection point, and an upper connection point in fluid communication with said air duct downstream of and near the choke point; and an atomization outlet in fluid communication with said upper gaseous region of said reservoir; wherein, air supplied by an unclaimed air supply enters the air inlet under pressure and travels into the air duct and through the choke point, converting the air into an air jet and lowering the downstream air pressure of the air duct near the choke point, creating a Venturi vacuum suctioning the liquid up the vacuum channel and into the air jet, thereby atomizing the liquid and propelling it into the gaseous region of the reservoir and out of the atomization outlet.

17. The system of claim 16, said system further comprising a manifold whereby the air supply supplies air to said air inlet, and includes an air delivery element in fluid communication with said air inlet, said manifold further comprising an attachment point, said cartridge further comprising an attachment element aligned and cooperating with said attachment point to removably secure the cartridge to the manifold.

18. The system of claim 17, said attachment element comprising a locking tab and said manifold attachment point comprising a tab receiver receiving said locking tab.

19. The system of claim 16, wherein the bottom of said cartridge is flat and said atomization outlet comprises closure means for leak-tight closure of the liquid.

20. The system of claim 19, said system further comprising a screw cap having internal threading, said closure means comprising external threading on said atomization outlet rotatably mating with the screw cap.

21. The system of claim 20, said external threading also functioning as a grasping element.
